(19) United States
(12) Patent Application Publication
(10) Pub. No.: US 2003/0186750 A1
(43) Pub. Date: Oct. 2, 2003

(54) 2004R billet input shaft

(76) Inventor: Bruce Andrew Toelle, Sacramento, CA (US)

Correspondence Address: Mark C. Jacobs, 3033 El Camino Avenue, Sacramento, CA, 95821, US

(21) Appl. No.: 10/109,729

(22) Filed: Apr. 1, 2002

(51) Int. Cl. F16C 3/00

(52) U.S. Cl. 464/179

(57) ABSTRACT

The 2004R Input Shaft is one of the parts in a 2004R Automatic Transmission, which was designed by General Motors. Under normal driving conditions the stock/factory input shaft does not usually break. But under severe duty and high performance driving these stock/factory input shafts are unable to handle the increased torque and power associated with this type of driving. The 2004R Billet Input Shaft is made from a hardened and heat-treated 300 M steel. This steel makes the Billet input shaft much more durable and considerably stronger than the stock/factory input shaft. Some of the “grooves” cut into the 2004R Billet Input Shaft have had the diameters changed (from the stock/factory blue print specifications) to accommodate teflon sealing rings, instead of using the factory metal rings. Teflon rings provide better sealing qualities. One end of the 2004R Billet Input Shaft has an oil feed hole which is smaller in diameter than the stock/factory hole. The purpose of the smaller diameter hole is to increase the oil pressure going to the lock-up circuit.

### BACKGROUND OF INVENTION

The 2004R input shaft is part of the 2004R automatic transmission that was designed by General Motors and is used in passenger vehicle applications.

The stock OEM factory input shaft is made from steel that is suitable for general purpose driving applications. These stock shafts are not able to withstand the power (torque) which is generated during high performance or severe duty conditions. Under these stressful conditions the shaft will break at the splined tip, thus causing transmission failure.

On one end of the shaft is a fluid feed hole to pressurize the lock up circuit. There are several grooves in the shaft, which accommodate different sizes of sealing rings. For normal driving applications these rings are of a metallic nature. These rings are replaced with rings made from a teflon material that provides superior sealing and pressure holding qualities.

### BRIEF SUMMARY OF THE INVENTION

The 2004R Billet Input Shaft is made from a hardened, heat-treated steel. The shaft is machined to the blue printed factory specifications. There are several grooves in the shaft, which are either enlarged or reduced in order to accommodate aftermarket sealing rings. The lock up feed hole has been reduced is diameter.

### DESCRIPTION OF INVENTION

The 2004R Billet Input Shaft is made from hardened and heat-treated 300 M steel. This steel is far superior in strength and durability to the material that a stock OEM shaft is made from. The 2004R Billet Input Shaft is machined to the factory blue printed specifications for the stock OEM input shaft. Do to the requirements of high performance and severe duty applications, several of the grooves on the Billet shaft have been changed. The diameters are either enlarged or reduced to accommodate teflon sealing rings. These teflon sealing rings replace the stock sealing rings because they can withstand the increase in fluid pressure and fluid temperature.

The lock up feed hole, located at one end of the shaft, has been reduced in diameter to increase fluid pressure going to the lock up circuit.

1: What I claim as my invention is that the Billet shaft is made from 300 M hardened, heat-treated steel.

2: What I claim as my invention is the diameters of the grooves have been either enlarged or reduced in size.

3: What I claim as my invention is the lock up feed hole has been reduced in diameter.
